(19) United States
(12) Patent Application Publication
(10) Pub. No.: US 2025/0383522 A1
(43) Pub. Date: Dec. 18, 2025

(54) SYSTEM AND METHOD FOR OPTICAL TESTING OF LARGE CONVEX MIRRORS

(71) Applicant: The Regents of the University of California, Oakland, CA (US)

(72) Inventors: Philip Hinz, Santa Cruz, CA (US); Renate Kupke, Santa Cruz, CA (US); Matthew Radovan, Santa Cruz, CA (US)

(21) Appl. No.: 19/237,566

(22) Filed: Jun. 13, 2025

Related U.S. Application Data
(60) Provisional application No. 63/659,997, filed on Jun. 14, 2024.

(51) Int. Cl. G02B 7/02; G01M 11/00

(52) U.S. Cl. CPC G02B 7/021; G01M 11/005; G02B 7/023

(57) ABSTRACT

A Hindle lens array for performing a Hindle test on a secondary mirror system of a telescope includes a plurality of lens assemblies, each housed within a frame structure that supports the lenses in an optically aligned configuration. The lens assemblies include a central lens and a plurality of peripheral lenses. The frame structure is secured using an adjustable hexapod, providing six degrees of freedom for fine alignment with the secondary mirror system. The Hindle lens array is an alternative to a single large Hindle mirror, mitigating weight-induced sagging and providing improved optical performance through modular alignment capabilities. In a method of performing a Hindle test using the Hindle lens array, a test wavefront is introduced, reflected, and analyzed to measure and correct wavefront distortions.

### CROSS-REFERENCE TO RELATED APPLICATIONS

This application claims the benefit of, and priority to, U.S. Provisional Patent Application Ser. No. 63/659,997 filed on Jun. 14, 2024. The entire contents of the foregoing application are incorporated by reference herein.

### BACKGROUND

High-precision optical systems, such as those used in large telescopes, require accurate metrology techniques to ensure proper alignment and wavefront correction. Precise calibration of the adaptive secondary mirror (ASM) of an astronomical telescope minimizes optical aberrations, which can degrade image quality. Traditional methods for optical testing and alignment include interferometric techniques that measure wavefront distortions and employ correction mechanisms to achieve an optimal optical path.

One technique for testing concave mirrors, particularly secondary mirrors in large optical systems, is the Hindle test. This method uses a specially designed spherical mirror called a “Hindle sphere” which acts as a reference surface to create an interference pattern revealing deviations from the desired shape. The test method provides a self-compensating optical test setup where the returning wavefront remains free of certain aberrations, allowing for precise characterization of mirror errors. However, the fabrication and alignment of large Hindle mirrors pose significant challenges, including cost, weight, and storage concerns. Furthermore, a fixed Hindle mirror limits flexibility in testing different optical configurations. Thus, there is a need for a versatile Hindle-based optical test system that can replicate the benefits of a traditional Hindle mirror while incorporating real-time adjustability, modular assembly, and adaptive corrections to improve the accuracy and efficiency of wavefront testing in large-scale telescope applications.

### SUMMARY

According to one embodiment of the present disclosure, a Hindle lens array for performing a Hindle test on a secondary mirror system of a telescope is disclosed. The Hindle lens array includes a plurality of lens assemblies having a central lens assembly and a plurality of peripheral lens assemblies, where the plurality of lens assemblies is configured to direct a test wavefront toward the secondary mirror system. The array also includes a frame structure supporting the plurality of lens assemblies and a support mechanism configured to attach the frame structure to the secondary mirror system.

According to another embodiment of the present disclosure, a method for performing a Hindle test using a Hindle lens array is disclosed. The method includes directing a test wavefront through a Hindle lens array toward a secondary mirror system. The Hindle lens array includes a plurality of lens assemblies having a central lens assembly and a plurality of peripheral lens assemblies, where the plurality of lens assemblies is configured to direct the test wavefront toward the secondary mirror system. A frame structure supports the plurality of lens assemblies, and a support mechanism is configured to attach the frame structure to the secondary mirror system. The method also includes reflecting the test wavefront back through the Hindle lens array after interaction with the secondary mirror system and analyzing the reflected test wavefront using an interferometer to measure optical aberrations in the secondary mirror system.

Implementations of the above embodiments may include one or more of the following features. According to one aspect of the above embodiment, the frame structure may include struts positioned along a perimeter thereof interconnecting adjacent peripheral lens assemblies of the plurality of lens assemblies. The support mechanism may include a plurality of adjustable mounting nodes arranged in a hexapod configuration. Each lens assembly may be individually adjustable in at least one of tip, tilt, and piston position to align with an optical axis of the secondary mirror system. Each lens assembly may include a lens housed within a lens frame. Each lens may have a thickness between 20 mm and 50 mm. At least one lens frame of the plurality of lens frames may include a mounting system having at least one adjustable hard point or a spring preload to stabilize the lens. At least one lens may be bonded to a corresponding lens frame of the plurality of lens frames. The plurality of lens assemblies may include six peripheral lens assemblies. The lens frame may have a hexagonal shape.

### BRIEF DESCRIPTION OF DRAWINGS

Various embodiments of the present disclosure are described hereinbelow with reference to the figures wherein:

FIG. 1 is a side view of a large reflecting telescope having an adaptive secondary mirror (ASM) and a Hindle lens array for performing a Hindle test on the ASM, according to the present disclosure;

FIG. 2 is a perspective view of the reflecting telescope of FIG. 1, illustrating the positioning of the ASM and Hindle lens array, according to the present disclosure;

FIG. 3 is an enlarged, top view of a platform supporting the ASM and Hindle lens array, showing the relative positioning of the components, according to one embodiment of the present disclosure;

FIG. 4 is an enlarged, perspective view of the platform supporting the ASM and Hindle lens array, highlighting mounting and alignment structures, according to one embodiment of the present disclosure;

FIG. 5 is a side view of a first embodiment of the ASM and Hindle lens array, showing their optical and mechanical configuration, according to the present disclosure;

FIG. 6 is a side view of a second embodiment of the ASM and Hindle lens array, illustrating an alternative mounting and alignment configuration, according to the present disclosure;

FIG. 7 is a side view of the second embodiment of the ASM, showing its structural details and mounting approach, according to the present disclosure;

FIG. 8 is a perspective, disassembled view of the second embodiment of the ASM, detailing internal structural components, according to the present disclosure;

FIG. 9 is a perspective view of the Hindle lens array, illustrating its frame structure and lens assemblies positioning, according to the present disclosure;

FIG. 10 is a perspective view of a lens assembly of the Hindle lens array of FIG. 9, highlighting lens positioning and mounting, according to one embodiment of the present disclosure;

FIG. 11 is a perspective view of a lens assembly of the Hindle lens array of FIG. 9, showing an alternative configuration, according to another embodiment of the present disclosure;

FIG. 12 is a finite element analysis (FEA) study of a 1500 mm diameter Hindle lens that is 150 mm thick, illustrating deformation under gravitational and mechanical loads, according to one embodiment of the present disclosure;

FIG. 13 is a FEA study of a 1500 mm diameter Hindle lens that is 200 mm thick according to one embodiment of the present disclosure;

FIG. 14 is a FEA study of a 1500 mm diameter Hindle lens that is 250 mm thick according to one embodiment of the present disclosure; and

FIG. 15 is a FEA study of a 500 mm diameter Hindle lens according to one embodiment of the present disclosure.

### DETAILED DESCRIPTION

The present disclosure relates to a metrology system for testing and aligning an ASM in a large reflecting telescope using a Hindle lens array. The system enables high-precision wavefront measurements by utilizing a lens-based Hindle test configuration, replacing the traditional Hindle concave mirror with an array of individually adjustable lenses.

A Hindle test is an optical metrology technique used to evaluate and align concave mirrors, particularly secondary mirrors in large telescopes, by creating a self-compensating test setup that minimizes optical aberrations in wavefront measurements. Traditionally, a concave Hindle mirror is positioned at a specific distance from the secondary mirror under test, ensuring that the returning wavefront remains free of certain aberrations and can be accurately analyzed using interferometry.

In the modified Hindle test described in the present disclosure, the Hindle lens array replaces the traditional Hindle concave mirror. This lens-based configuration refracts and conditions the test wavefront instead of reflecting it, allowing for greater adjustability and modularity in wavefront analysis. The Hindle lens array directs the wavefront toward the ASM, enabling real-time optical alignment and correction. The wavefront may be then analyzed using interferometry techniques.

The Hindle lens array is positioned along the optical axis of the telescope to condition and direct a test wavefront onto the ASM, allowing for the detection and correction of wavefront distortions. The system incorporates a hexapod mounting mechanism for precise alignment, a frame structure for supporting the Hindle lens array, and counterweights attached to the ASM to maintain optical stability. Finite element analysis (FEA) simulations were used to validate the structural integrity of different Hindle lens configurations under operational conditions.

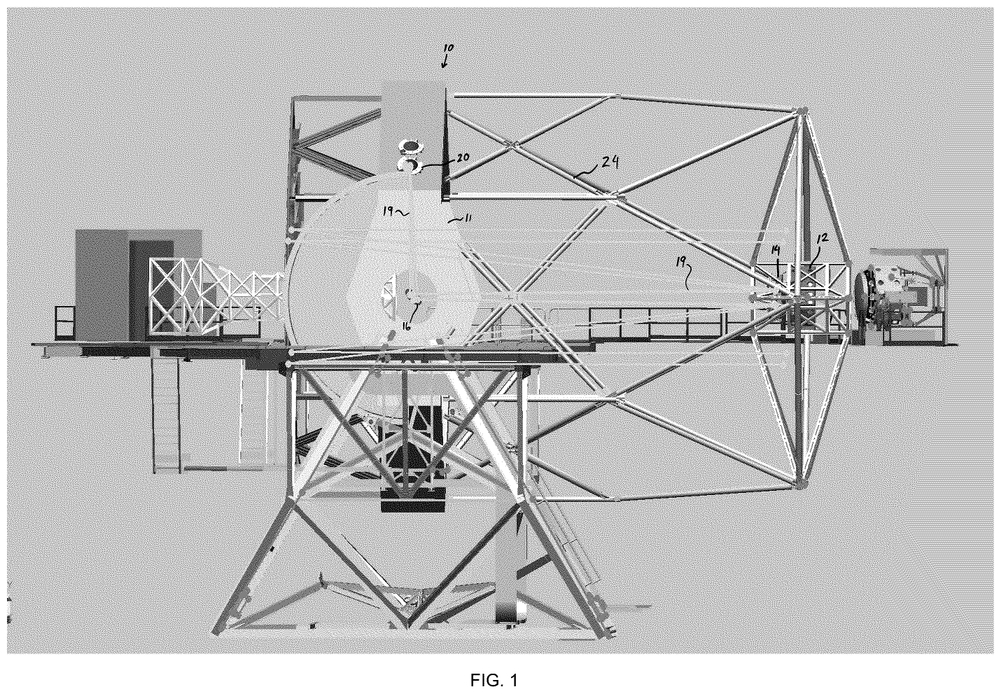

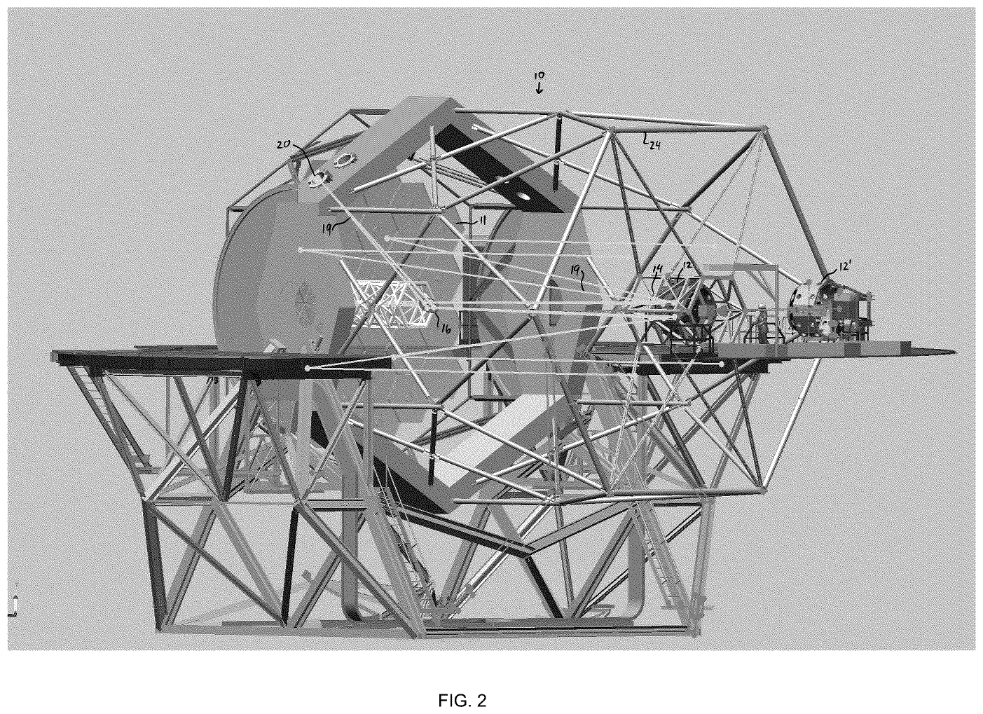

FIG. 1 illustrates a side, partially disassembled view of a large reflecting telescope system 10, such as the Keck Observatory Telescope, specifically one of the Keck I or Keck II telescopes, which are 10-meter-class Ritchey-Chrétien reflecting telescopes located at the W. M. Keck Observatory on Mauna Kea, Hawaii. These telescopes utilize a segmented primary mirror, an ASM, and advanced adaptive optics to enable high-resolution astronomical observations. The telescope system 10 includes a primary mirror 11, a secondary mirror system 12, a Hindle lens array 14, a tertiary mirror 16, and an interferometer or any other suitable testing device (not shown) for performing a Hindle test on the secondary mirror system 12. The light path 19 originates from the interferometer and passes through an instrument port 20 and reflects off the tertiary mirror 16 toward the secondary mirror system 12 and the Hindle lens array 14. The light is then reflected back along the same optical path, passing through the Hindle lens array 14 and secondary mirror system 12 before being directed again by the tertiary mirror 16 toward the port 20. The telescope system 10 also includes the primary mirror 11, which is positioned within a supporting structure 24. During use, the secondary mirror system 12 is positioned along the optical axis forward of the primary mirror 11 and is held in place by a support spider, ensuring proper alignment and stability within the supporting structure 24. During testing, the supporting structure 24 is rotated into a horizontal position as shown in FIGS. 1 and 2, e.g., the light path 19 reflected from the tertiary mirror 16 toward the secondary mirror system 12 is parallel to the ground. The Hindle lens array 14 is positioned in front of the secondary mirror system 12 along the optical axis to enable accurate wavefront measurement and alignment.

FIG. 2 provides a perspective, partially disassembled view of the reflecting telescope system 10 of FIG. 1, offering an alternative vantage point to illustrate the relative positioning of the primary mirror 11, the secondary mirror system 12, Hindle lens array 14, and the tertiary mirror 16, and the light path 19. The port 20 is more clearly visible, directing the light path from the testing equipment to the tertiary mirror 16, which then reflects the beam toward the secondary mirror system 12 and Hindle lens array 14.

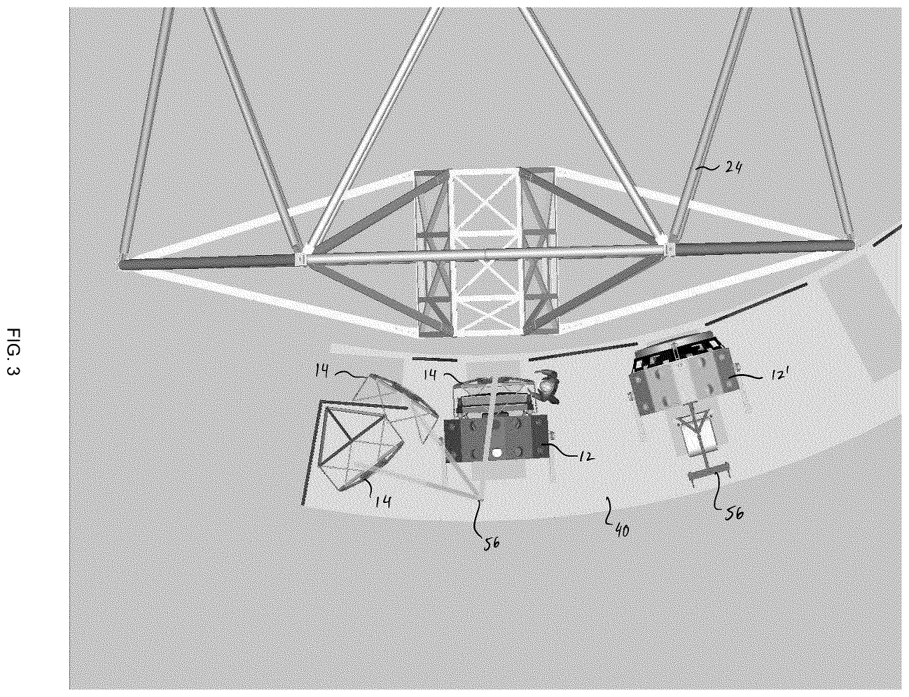

With reference to FIG. 3, a platform 40 is used to store the secondary mirror system 12, the Hindle lens array 14, and an additional secondary mirror system 12′ when these components are not attached to the supporting structure 24. The Hindle lens array 14 is stored on the platform 40 and aligned with the secondary mirror system 12 to facilitate wavefront measurements as part of the Hindle test procedure. Adjacent to the secondary mirror system 12, an additional secondary mirror system 12′ is also positioned on the platform 40, allowing for testing, storage, or interchangeability of the secondary mirror systems 12 and 12′. The secondary mirror system 12′ may serve as a backup, an alternative optical configuration, or a different secondary mirror design under evaluation by the telescope system 10.

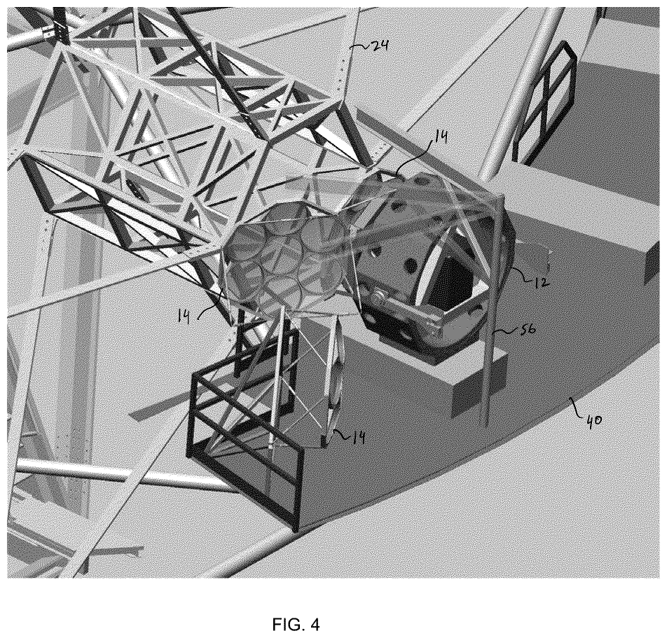

Both the secondary mirror systems 12 and 12′ and the Hindle lens array 14 may be supported and maneuvered using mechanical lifting devices 56, such as overhead cranes, hoists, and lifting frames, which enable precise positioning and safe handling of these components. The lifting devices 56 are designed to transport the secondary mirror systems 12 and 12′ between different locations on the platform 40, facilitating installation, removal, or alignment with the telescope structure. The lifting devices 56 provide additional stability during movement, ensuring that the mirrors are not subjected to excessive mechanical stress. The Hindle lens array 14 is also handled using similar lifting mechanisms, allowing it to be positioned precisely along the optical path for metrology testing as shown in FIG. 4 with respect to secondary mirror system 12.

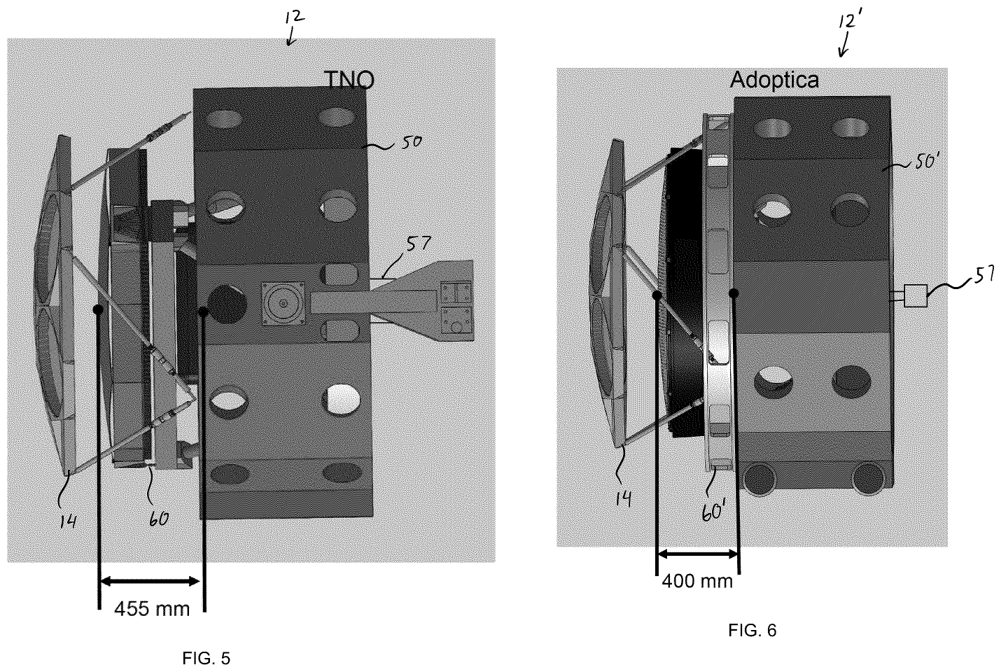

FIG. 5 illustrates the secondary mirror system 12, which includes a housing 50 designed to securely hold an ASM 60, which may be an ASM designed by AdOptica a consortium of Microgate and A.D.S. International. The housing 50 features structural reinforcements and mounting points to ensure stability and precise alignment of the ASM 60. The Hindle lens array 14 is shown attached to the housing 50, positioned to facilitate wavefront measurements as part of the Hindle test procedure. FIG. 6 shows the secondary mirror system 12′ which also includes a housing 50′ and an ASM 60′. The ASM 60′ may be an ASM designed by TNO of Netherlands.

A counterweight 57 may be attached to the secondary mirror systems 12 and 12′ to compensate for imbalances introduced by the Hindle lens array 14 or other optical components mounted to the secondary mirror system. The counterweight 57 ensures stable positioning and proper load distribution, preventing unwanted mechanical deflections or tilting that could misalign the optical system. By counteracting the additional mass introduced by the Hindle lens array 14, the counterweight 57 helps maintain the structural integrity and precise alignment of the secondary mirror systems 12 and 12′ during metrology testing and telescope operation. The counterweight 57 may be adjustable or modular, allowing fine-tuned balancing based on specific testing configurations or variations in the optical payload.

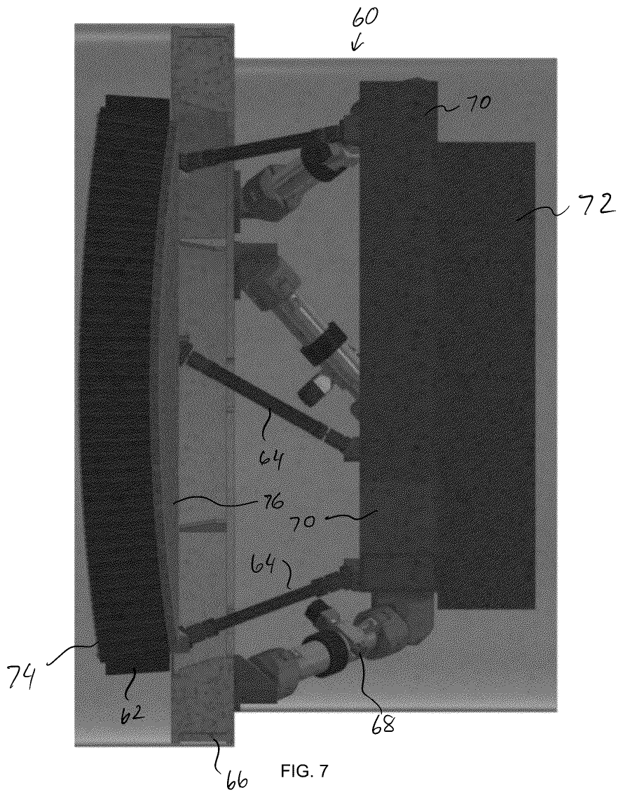

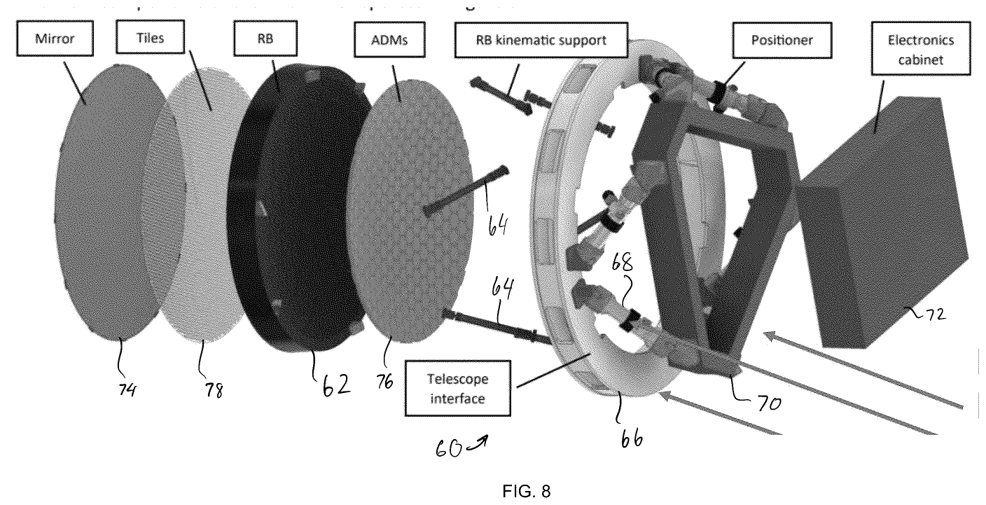

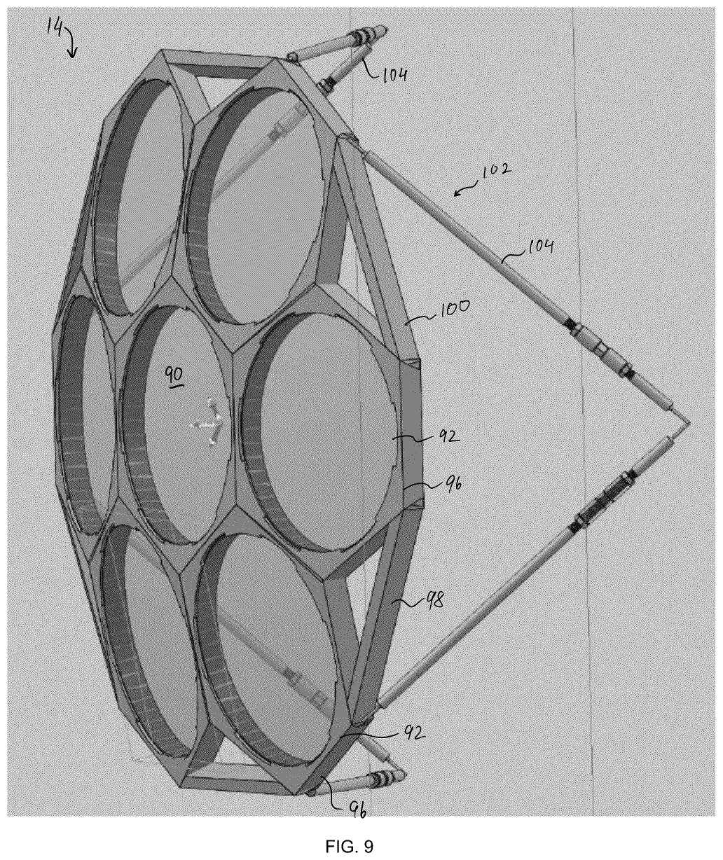

FIGS. 7 and 8 illustrate the ASM 60, which is a contactless adaptive mirror system designed for high-precision wavefront correction in astronomical telescopes. The ASM 60 includes a reference body (RB) 62, which serves as a rigid, thermally stable support structure for the adaptive optics components. The reference body 62 is supported by kinematic supports 64, which may be arranged in a hexapod configuration and provide precise mechanical alignment and ensure the stability of the ASM 60 within the telescope system. These kinematic supports 64 interface with a frame 70, which integrates the ASM 60 with the housing 50. As used herein, a mount is considered kinematic if all degrees of freedom are fully constrained.

The telescope interface 66 is further supported by positioners 68, which allow for fine-tuned adjustments to align the ASM 60. The positioners 68 may be arranged in a hexapod configuration and are connected to the frame 70, which provides structural reinforcement and serves as the primary load-bearing element for the ASM 60. The frame 70 is coupled to an electronics cabinet 72, which houses the high-speed digital and analog control systems responsible for real-time mirror adjustments. These electronics process approximately 70,000 measurements per second, updating the position and shape of a mirror 74 at a rate of 1 millisecond, enabling precise and continuous wavefront correction.

The ASM 60 also includes a mirror 74, which may be approximately 1.6 mm thick, that is actively controlled in both position and shape by a large number of adaptive mirror driver modules (ADMs) 76. These ADMs 76, implemented as voice coil motors, generate an electromagnetic field that allows the mirror 74 to levitate without mechanical contact, eliminating friction and hysteresis. The gap between the mirror 74 and the reference body 62 may be continuously measured by capacitive sensor armatures, ensuring precise wavefront correction with a typical operating range between 40 and 120 μm.

Positioned between the mirror 74 and the reference body 62, a layer of tiles 78 (FIG. 8) provides mechanical support, structural reinforcement, and thermal stability to the ASM 60. The tiles 78 help to distribute forces applied by the ADMs 76, reducing localized stress and ensuring uniform deformation of the mirror 74 during adaptive optics operation. Additionally, the tiles 78 enhance the coupling between the mirror 74 and the reference body 62, maintaining alignment and mechanical integrity.

During operation, the ASM 60 may dynamically adjust the surface of the mirror 74 to compensate for atmospheric turbulence, optical misalignments, and thermal distortions. The ADMs 76 eliminate mechanical friction and allow for precise and repeatable wavefront corrections. Even in the event of an actuator failure, the system can continue operating with minimal performance degradation, ensuring continuous functionality. Additionally, the mirror 74 can be actively locked into a rigid configuration, allowing it to function as a conventional secondary mirror when adaptive optics are not required.

IG. 9 illustrates the Hindle lens array 14, which is configured to provide wavefront measurements for metrology testing of the ASM 60. The Hindle lens array 14 includes a plurality of lens assemblies, including a central (e.g., on-axis) lens assembly 90 and multiple peripheral lens assemblies 92, arranged in a hexagonal configuration around the central lens assembly 90. Each lens assembly 90 and 92 is housed within a hexagonal frame 96, which enables precise tessellation and ensures structural stability while maximizing optical coverage. The peripheral lens assemblies 92 are symmetrically arranged around the central lens assembly 90, forming a compact and optically efficient structure. This configuration allows for consistent wavefront measurements across the array, ensuring uniform performance during metrology testing.

The Hindle lens array 14 is further reinforced by struts 98, which extend along its perimeter to provide mechanical stability and minimize deformation under gravitational and operational loads. These struts 98 extend between the peripheral lens assemblies 92 and enhance structural integrity during handling and testing procedures. Thus, the struts 98 along with the lens assemblies 90 and 92 form a frame 100.

The Hindle lens array 14 may include any number of peripheral lens assemblies 92, including but not limited to two, three, four, or more peripheral lenses surrounding one or more central lens assemblies 90. The number of lenses used in the array can be adjusted based on optical requirements, mechanical constraints, and available mounting space of the ASM 60. The arrangement and shape of the lens assemblies 90 and 92 are configured to ensure that the lens assemblies fit together in a structurally stable and optically efficient configuration. As the number of peripheral lenses increases, the shape of the frame 96 for each lens assembly may be adapted to optimize packing density while maintaining structural integrity and alignment with the optical axis of the ASM 60. For example, with one central lens assembly 90 and four peripheral lens assemblies 92, the frames 96 may have a square shape to form a combined cross shape. The frame structure of each lens assembly is designed to allow secure attachment within the Hindle lens array 14, ensuring that the lenses remain properly positioned for performing the Hindle test. Additionally, the modularity of the design allows for different geometries and configurations, ensuring flexibility in adapting the Hindle lens array 14 to various telescope architectures and testing conditions.

The frame 100 of the Hindle lens array 14 is designed to attach to the telescope interface 66 of the ASM 60 with an adjustable support mechanism 102, enabling manual alignment of the entire lens array system. The support mechanism 102 may be a hexapod, which provides six degrees of freedom, allowing for precise adjustments in tip, tilt, and piston position to achieve optical alignment between the Hindle lens array 14 and the ASM 60. The support mechanism 102 includes a plurality of nodes 104, which serve as attachment points between the frame 100 of the Hindle lens array 14 and the frame 70 of the ASM 60. The nodes 104 may be removable and kinematic, allowing for easy maintenance, replacement, or reconfiguration of the lens assemblies 90 and 92. As used herein, a mount is considered kinematic if all degrees of freedom are fully constrained. The frame 100 may be formed from metal and may be constructed as a single-piece structure or a bolted assembly, depending on structural and mechanical requirements. Additionally, composite construction may also be used to provide a lightweight and rigid support structure for the lens assemblies 90 and 92.

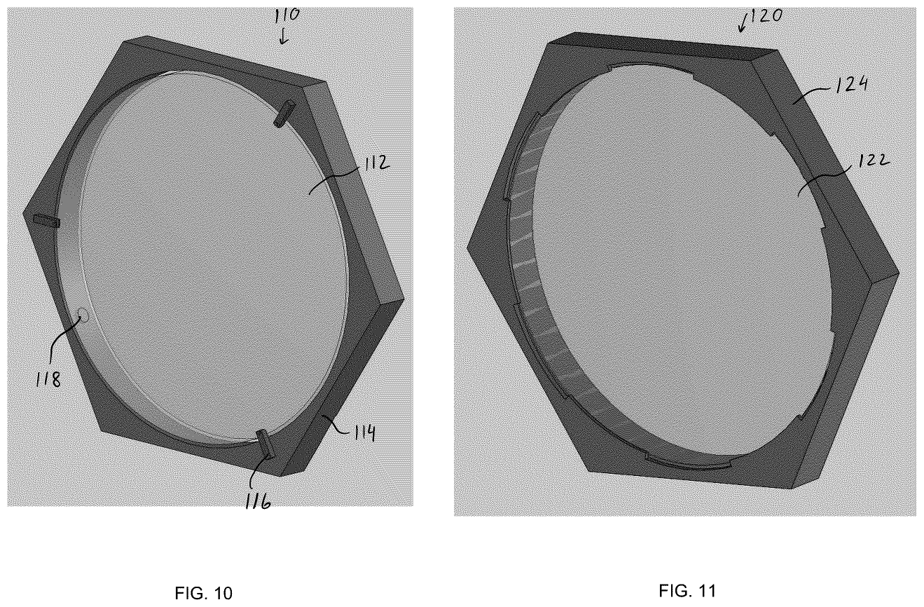

FIG. 10 illustrates a first embodiment of a Hindle lens assembly 110, which may be used as one of the lens assemblies 90 and 92 in the Hindle lens array 14. The Hindle lens assembly 110 includes a lens 112 that is secured within a hexagonal frame 114. The hexagonal frame 114 provides structural reinforcement, allowing the lens assembly 110 to fit seamlessly within the tessellated Hindle lens array 14. The hexagonal frame 114 may be formed from metal or a composite material to provide for structural integrity.

The lens 112 may be held in place using adjustable hard points 116 and spring preloads 118, ensuring a stable yet flexible mounting configuration that allows for fine adjustments while minimizing mechanical stress on the optical element. The adjustable hard points 116 and spring preloads 118 ensure that each lens remains precisely aligned during metrology operations while allowing for controlled realignment when necessary.

Each lens 112 positioned on the perimeter of the Hindle lens array 14 is designed to be adjustable to align with the central on-axis lens, ensuring optimal optical performance across the array. This adjustability is achieved through precision tip, tilt, and piston controls, which allow for individual lens realignment within the frame 100. These adjustments help compensate for manufacturing tolerances, mechanical flexure, and thermal expansion, ensuring a uniform optical surface across the array.

The diameter of the lens 112 is dependent on the total number of lenses used in the Hindle lens array 14. For example, fewer lenses would require larger diameters, whereas a greater number of lenses would allow for smaller individual lens diameters while maintaining the same overall aperture. The lens 112 may have a thickness between 20 mm and 50 mm, depending on the structural and optical requirements of the Hindle test setup. The lens 112 may have a diameter of about ⅓ of the diameter of the mirror 74 of the ASM 60 since it takes three lenses 112 to fit the diameter of the mirror 74.

The lens 112 may be constructed from high-quality optical materials such as fused silica, BK7 glass, or low-expansion materials like Zerodur or ULE (Ultra-Low Expansion glass). These materials may be chosen based on their optical clarity, thermal stability, and resistance to environmental distortions, ensuring consistent performance in precision wavefront metrology applications.

FIG. 11 illustrates another embodiment of a Hindle lens assembly 120, which may be used as one of the lens assemblies 90 and 92 in the Hindle lens array 14. Unlike the embodiment shown in FIG. 10, where the lens is secured using adjustable hard points and spring preloads, the lens 122 in this configuration is bonded to the hexagonal frame 124 using an adhesive, such as a room-temperature vulcanizing (RTV) adhesive. This bonding method provides a secure, stress-distributed attachment, minimizing mechanical stress concentrations that could lead to optical distortions.

To ensure precise optical alignment, the lens 122 must be correctly positioned before the bonding process. Any misalignment prior to bonding could introduce permanent optical errors, making the pre-bonding alignment procedure critical. The bonding process may be conducted in a horizontal orientation (e.g., a principal plane of the lens is parallel to the ground), where gravity effects are minimized, ensuring that the adhesive cures evenly without introducing tilt or shift in the lens placement. For brevity, other features of the Hindle lens assembly 120, such as its hexagonal frame structure, role in the Hindle lens array 14, and individual lens adjustability in tip, tilt, and piston position, are similar to those described in FIG. 10 and are not repeated here.

In further embodiments, a hybrid design for the Hindle lens assembly 120 could incorporate an embedded adjuster to compensate for gravity-induced errors when the assembly is tilted to a vertical orientation. This embedded adjuster would allow for fine-tuned corrections after bonding, ensuring the optical axis remains properly aligned when the Hindle lens array 14 is repositioned during testing or operation.

The Hindle test using the Hindle lens array 14 is performed to evaluate the wavefront accuracy and optical performance of the ASM 60 in a large reflecting telescope. Unlike traditional Hindle tests that rely on a single concave Hindle sphere, this system incorporates the Hindle lens array 14, allowing for greater flexibility and precision in accommodating the adaptive capabilities of the ASM 60. The Hindle lens array 14 is mounted to the ASM 60 via the support mechanism 102, which provides six degrees of freedom, enabling precise alignment in tip, tilt, and piston position to ensure proper optical calibration. Each lens 112 within the Hindle lens array 14 is individually adjustable, allowing the peripheral lenses to align with the on-axis shell of the telescope.

To initiate the Hindle test, a coherent light source, e.g., an interferometer, introduces a wavefront into the system through a designated right-bent Cass port 20. The wavefront passes through the Hindle lens array 14, where the lenses collimate and direct the light toward the ASM 60. The mirror 74 of the ASM 60 reflects the wavefront back through the Hindle lens array 14, where the returning wavefront is analyzed using interferometric techniques to detect wavefront distortions and optical aberrations.

The Hindle lens array 14 provides several key advantages over traditional Hindle sphere setups. Its hexagonal arrangement of individually adjustable lens assemblies 110 and 120 allows for greater control over wavefront shaping and alignment. The nodes 104 provide an adjustable, yet stable and repeatable mounting system, reducing misalignment errors during testing. Additionally, different configurations of the Hindle lens assemblies 110 and 120, such as spring-preloaded or RTV-bonded lenses, provide further flexibility in optimizing the alignment for specific testing conditions.

By incorporating the Hindle lens array 14 in place of a conventional Hindle sphere, this Hindle test setup provides a highly adaptable and precise method for evaluating the optical performance of the ASM 60. The combination of adjustable optics, real-time adaptive corrections, and fine mechanical alignment ensures that large aperture reflecting telescopes achieve the highest possible optical precision.

From the foregoing, it will be appreciated that specific embodiments of the disclosure have been described herein for purposes of illustration, but that various modifications may be made without deviating from the scope of the disclosure. Accordingly, the disclosure is not limited except as by the appended claims. The following Examples illustrate embodiments of the present disclosure. These Examples are intended to be illustrative only and are not intended to limit the scope of the present disclosure. Also, parts and percentages are by weight unless otherwise indicated.

### EXAMPLES

### Example 1

This example describes FEA study of a 1500 mm diameter Hindle lens at 150 mm, 200 mm, and 250 mm thicknesses.

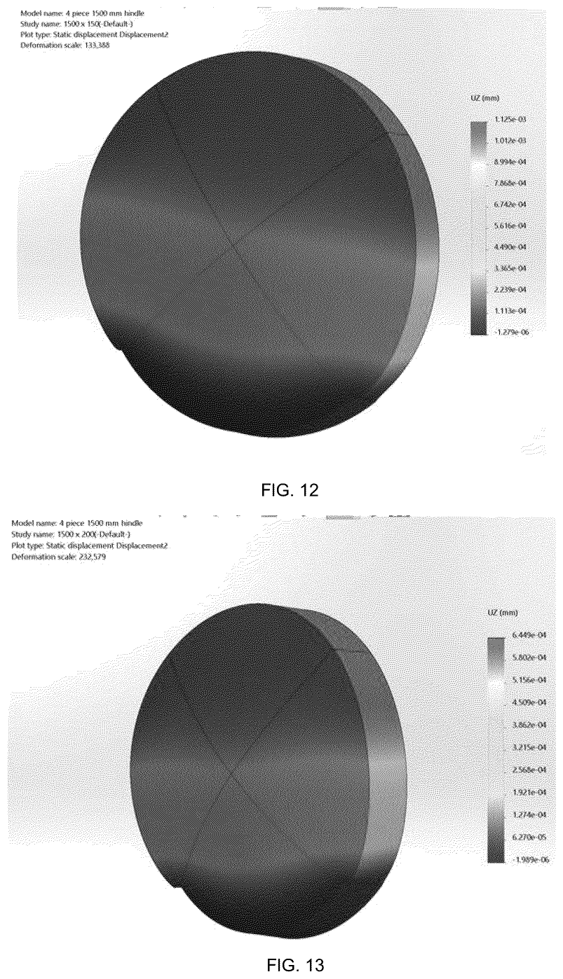

FIGS. 12-14 illustrate FEA models evaluating the structural performance of a 1500 mm Hindle lens at varying thicknesses, specifically 150 mm, 200 mm, and 250 mm, with their corresponding masses of 664 kg, 888 kg, and 1108 kg, respectively. These analyses assess the feasibility of using a single large Hindle lens as an alternative to the Hindle lens array 14. While a single large lens could theoretically replace the segmented lens array, its substantial mass presents significant mechanical and optical challenges.

An issue arises due to the orientation of the Hindle lens during testing. In a Hindle test, the lens is positioned horizontally, which causes gravitational sagging that can adversely impact optical performance. The FEA models in FIGS. 12-14 depict the deformation profiles for each lens thickness, showing how the gravitational load induces deflection across the lens surface. The color-coded displacement maps highlight areas of sagging, with increasing thickness reducing deformation but at the cost of additional weight, making handling and mounting more complex.

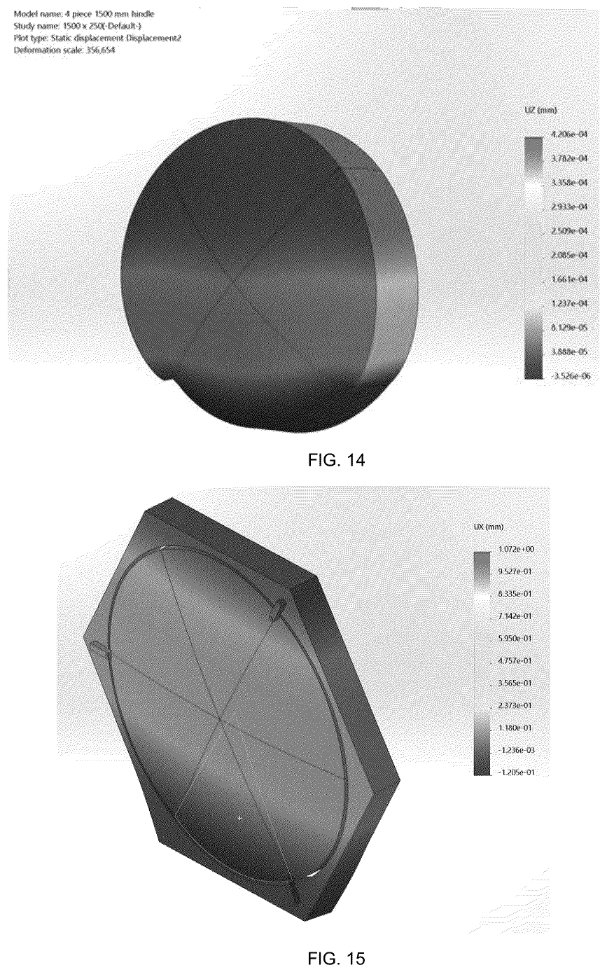

FIG. 12 shows the 150 mm thick Hindle lens, which, at 664 kg, exhibits significant sagging under its own weight, leading to unacceptable distortions in wavefront propagation. FIG. 13 illustrates the 200 mm thick lens, weighing 888 kg, which shows reduced sagging but still experiences measurable deformation that could degrade metrology accuracy. FIG. 14 presents the 250 mm thick lens, with a mass of 1108 kg, which provides the most structural rigidity but remains excessively heavy, posing practical challenges for mounting, alignment, and handling within the telescope system.

Given these limitations, using a single large Hindle lens as an alternative to the Hindle lens array 14 introduces undesirable trade-offs between weight and optical accuracy. The gravitational sag observed in the FEA models suggests that maintaining optical precision with a single lens would require additional support structures, active compensation mechanisms, or thicker lens designs—each adding further complexity. In contrast, the Hindle lens array 14, composed of multiple lighter, individually adjustable lenses, offers a more practical solution, minimizing sagging effects while allowing for fine-tuned optical corrections in metrology applications.

### Example 2

This example describes FEA study of a 500 mm diameter Hindle lens.

FIG. 15 illustrates a FEA model of an adjustable Hindle lens assembly, demonstrating an alternative design that mitigates weight-induced sagging issues observed in the single large-lens configurations shown in FIGS. 12-14. Unlike those designs, which suffer from significant gravitational deformation due to their mass, the adjustable Hindle lens assembly 130 shown in FIG. 15 incorporates structural reinforcements and active adjustment mechanisms to maintain optical precision.

The Hindle lens assembly features a 500 mm-class lens, which is supported within a hexagonal frame. The lens is kinematically mounted using adjustable hard points, allowing for precise realignment in tip, tilt, and piston position. The FEA model illustrates how this adjustable support system distributes loads more efficiently, significantly reducing wavefront distortion compared to a single large Hindle lens. The hexagonal frame provides rigid structural support, preventing excessive flexure while keeping the system lightweight and modular.

Unlike the single large Hindle lenses analyzed in FIGS. 12-14, which exhibited significant sagging under horizontal orientation, this adjustable design incorporates fine-tuned support mechanisms that actively correct for gravity-induced distortions. The adjustable hard points allow for real-time optical correction, ensuring that the wavefront remains stable regardless of the telescope's orientation. Additionally, the kinematic mounting system ensures that each lens maintains a consistent optical alignment while allowing for recalibration and modular replacement when necessary.

The FEA results confirm that this design maintains superior optical performance with minimal deformation, making it a more practical and scalable solution for Hindle test applications. By integrating adjustable optics, lighter individual lens elements, and active correction mechanisms, this design eliminates the weight-induced challenges faced by single large Hindle lenses, ensuring high-precision wavefront measurements in metrology applications.

Alternate embodiments may be devised without departing from the spirit or the scope of the present technology. Additionally, well-known elements of embodiments of the systems, apparatuses, and methods have not been described in detail or have been omitted so as not to obscure the relevant details of the systems, apparatuses, and methods.

The terminology used herein is for the purpose of describing particular embodiments only and is not intended to be limiting. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. The terms “including” and/or “having,” as used herein, are defined as comprising (i.e., open language). The terms “a” or “an”, as used herein, are defined as one or more than one. The term “plurality,” as used herein, is defined as two or more than two. The term “another,” as used herein, is defined as at least a second or more. The description may use the terms “embodiment” or “embodiments,” which may each refer to one or more of the same or different embodiments.

When the terms “coupled” and “connected,” along with their derivatives, are used, these terms are not intended as synonyms for each other. For example, “connected” may be used to indicate that two or more elements are in direct physical or electrical contact with each other. “Coupled” may mean that two or more elements are in direct physical or electrical contact (e.g., directly coupled) or that two or more elements are not in direct contact with each other but yet still cooperate or interact with each other (e.g., indirectly coupled).

For the purposes of the description, a phrase in the form “A/B” or in the form “A and/or B” or in the form “at least one of A and B” means (A), (B), or (A and B), where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables, for example, a phrase in the form “at least one of A, B, and C” means (A), (B), (C), (A and B), (A and C), (B and C), or (A, B and C).

Relational terms such as first and second, top and bottom, and the like may be used solely to distinguish one entity or action from another entity or action without necessarily requiring or implying any actual such relationship or order between such entities or actions. The description may use perspective-based descriptions such as up/down, back/front, top/bottom, and proximal/distal. Such descriptions are merely used to facilitate the discussion and are not intended to restrict the application of disclosed embodiments. Various operations may be described as multiple discrete operations in turn, in a manner that may be helpful in understanding embodiments; however, the order of description should not be construed to imply that these operations are order dependent.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. As used herein, the terms “substantial” and “substantially” means, when comparing various parts to one another, that the parts being compared are equal to or are so close enough in dimension that one skill in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

Various embodiments of the systems, apparatuses, and methods have been described, and in many of the different embodiments many features are similar. To avoid redundancy, repetitive description of these similar features may not be made in some circumstances. It shall be understood, however, that description of a first-appearing feature applies to the later described similar feature and each respective description, therefore, is to be incorporated therein without such repetition.

What is claimed is:

1. A Hindle lens array for performing a Hindle test on a secondary mirror system of a telescope, Hindle lens array comprising:
a plurality of lens assemblies, including a central lens assembly and a plurality of peripheral lens assemblies, wherein the plurality of lens assemblies is configured to direct a test wavefront toward the secondary mirror system;
a frame structure supporting the plurality of lens assemblies; and
a support mechanism configured to attach the frame structure to the secondary mirror system.

2. The Hindle lens array of claim 1, wherein the frame structure includes struts positioned along a perimeter thereof interconnecting adjacent peripheral lens assemblies of the plurality of lens assemblies.

3. The Hindle lens array of claim 1, wherein the support mechanism includes a plurality of adjustable mounting nodes arranged in a hexapod configuration.

4. The Hindle lens array of claim 1, wherein each lens assembly is individually adjustable in at least one of tip, tilt, and piston position to align with an optical axis of the secondary mirror system.

5. The Hindle lens array of claim 1, wherein each lens assembly includes a lens housed within a lens frame of a plurality of lens frames.

6. The Hindle lens array of claim 5, wherein each lens has a thickness between 20 mm and 50 mm.

7. The Hindle lens array of claim 5, wherein at least one lens frame of the plurality of lens frames includes a mounting system having at least one adjustable hard point or a spring preload to stabilize the lens.

8. The Hindle lens array of claim 5, wherein at least one lens is bonded to a corresponding lens frame of the plurality of lens frames.

9. The Hindle lens array of claim 5, wherein the plurality of lens assemblies includes six peripheral lens assemblies.

10. The Hindle lens array of claim 9, wherein the lens frame has a hexagonal shape.

11. A method for performing a Hindle test using a Hindle lens array, comprising:
directing a test wavefront through a Hindle lens array toward a secondary mirror system, the Hindle lens array including:
a plurality of lens assemblies, including a central lens assembly and a plurality of peripheral lens assemblies, wherein the plurality of lens assemblies is configured to direct the test wavefront toward the secondary mirror system;
a frame structure supporting the plurality of lens assemblies; and
a support mechanism configured to attach the frame structure to the secondary mirror system;
reflecting the test wavefront back through the Hindle lens array after interaction with the secondary mirror system; and
analyzing the reflected test wavefront using an interferometer to measure optical aberrations with the secondary mirror system.

12. The method of claim 11, wherein the frame structure includes struts positioned along a perimeter thereof interconnecting adjacent peripheral lens assemblies of the plurality of lens assemblies.

13. The method of claim 11, wherein the support mechanism includes a plurality of adjustable mounting nodes arranged in a hexapod configuration.

14. The method of claim 11, wherein each lens assembly is individually adjustable in at least one of tip, tilt, and piston position to align with an optical axis of the secondary mirror system.

15. The method of claim 11, wherein each lens assembly includes a lens housed within a lens frame of a plurality of lens frames.

16. The method of claim 15, wherein each lens has a thickness between 20 mm and 50 mm.

17. The method of claim 15, wherein at least one lens frame of the plurality of lens frames includes a mounting system having at least one adjustable hard point or a spring preload to stabilize the lens.

18. The method of claim 15, wherein at least one lens is bonded to a corresponding lens frame of the plurality of lens frames.

19. The method of claim 15, wherein the plurality of lens assemblies includes six peripheral lens assemblies.

20. The method of claim 19, wherein the lens frame has a hexagonal shape.
